(19) United States
(12) Patent Application Publication
(10) Pub. No.: US 2019/0366283 A1
(43) Pub. Date: Dec. 5, 2019

(54) MIXER BOTTLE

(71) Applicant: Inventcor, LLC, Kirkland, WA (US)

(72) Inventor: Michael BUCKLEY, Kirkland, WA (US)

(21) Appl. No.: 16/483,215

(22) PCT Filed: Feb. 5, 2018
(86) PCT No.: PCT/US18/16817

§ 371 Date: Aug. 2, 2019

Related U.S. Application Data
(60) Provisional application No. 62/454,065, filed on Feb. 3, 2017.

(51) Int. Cl. B01F 13/00; A47J 43/27; B01F 15/00; B01F 11/00; B65D 1/04

(52) U.S. Cl. CPC B01F 13/002; A47J 43/27; B01F 15/00512; B65D 2217/04; B65D 1/04; B65D 2217/02; B01F 11/0005

(57) ABSTRACT

A bottle assembly for storing and mixing liquids includes a lid having a removable screen member. The screen member can have resilient tab members, which in turn, comprise inwardly protruding retaining members for use in attaching the screen member to the lid. The screen member can be convex in shape relative to the lid and can be partially spherical, or approximate a partial or half sphere. Also, in some embodiments, the screen member includes reinforcement structures proximate the resilient tab members for preventing over extension of the tab members.

### CROSS REFERENCE TO RELATED APPLICATION(S)

This application claims priority to U.S. Provisional Patent Application No. 62/454,065, filed on Feb. 3, 2017, which is incorporated herein by reference in its entirety.

### BACKGROUND

### 1. Technical Field

The present disclosure relates to liquid container apparatuses, and more particularly, to apparatuses for mixing liquids stored, transported, and dispensed via liquid bottles.

### 2. Description of Related Art

In recent years, sports drinks, protein shakes, and other types of nutritional drinks have enjoyed increasing popularity with consumers. These nutritional drinks can be sold as already-made drinks in cans/carton ready to be immediately consumed straight out of cans or carton, or can be sold as a dry powder mix or a concentrate to be mixed with water or other types of consumable fluids (e.g., juice) by the consumer to produce the final form of the drink. These nutritional drinks are often stored, transported, and consumed out of drinking bottles. Unfortunately, when these nutritional drinks are stored in these drinking bottles, the ingredients tend to separate out, particularly when the drinking bottles containing these drinks remain stationary for any length of time.

### BRIEF DESCRIPTION OF THE DRAWINGS

FIG. 1 is a side elevation view of an example drinking bottle assembly for various embodiments of the present disclosure, also showing directional lines for reference purposes only, “V” representing a vertical direction and “H” representing a horizontal direction.

FIG. 2 is bottom perspective view of the lid of the drinking bottle assembly of FIG. 1.

FIG. 3 is a top perspective view of a screen member with tabs contained in the drinking bottle assembly of FIG. 1.

FIG. 4 is a simplified partial cross sectional and cutaway view showing the bottle body of FIG. 1 and also showing the lid of FIG. 1 (the cross section of the bottle body and lid are illustrated in simplified form and by broken line to avoid obscuring features described herein), and a screen member of FIG. 3 releasably secured to the lid.

FIG. 5 is combination cutaway view of an alternative embodiment for the lid and a top perspective view of an alternative embodiment for the screen member.

### DETAILED DESCRIPTION

In the present description, certain specific details are set forth in order to provide a thorough understanding of various embodiments of the disclosure. However, upon reviewing this disclosure one skilled in the art will understand that the various embodiments disclosed herein may be practiced without many of these details. In other instances, some well-known structures and materials of construction have not been described in detail to avoid unnecessarily obscuring the descriptions of the embodiments of the disclosure.

In the present disclosure, to the extent the terms “about” and “approximately,” are used, they mean ±20% of the indicated range, value, or structure, unless otherwise indicated. In the present description, the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, the terms and variants of which are intended to be construed as non-limiting. The definitions in this paragraph are intended to apply throughout this disclosure unless otherwise expressly stated.

In some embodiments of the present disclosure, a drinking bottle assembly is provided that may make it easier to mix or blend fluids prior to, for example, the fluids being dispensed or consumed. In various embodiments, the drinking bottle assembly includes a lid for the drinking bottle, the lid having a screen configured for use in mixing or blending fluids (e.g., liquids with powdered form supplements, or flavoring, or both, deposited by a user into the liquid within a bottle portion of the bottle assembly prior to the fluids being dispensed from the drinking bottle). In some embodiments, the bottle portion of the bottle assembly couples with the lid, such as by a screw-on threaded interior surface portion of the lid, and a mating exterior threaded receiving neck portion of the bottle portion.

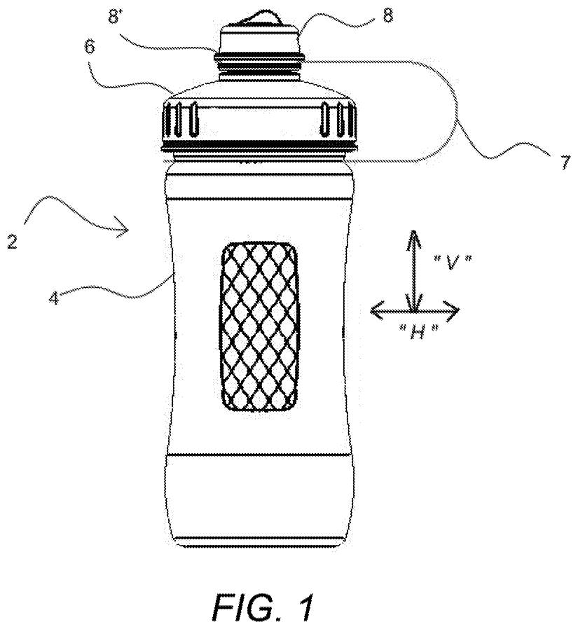

FIG. 1 illustrates a drinking bottle in accordance with some embodiments (FIG. 1 illustrates the drinking bottle disposed in upright fashion, defining a vertical “V” axis and horizontal “H” axis, which reference positions will be used throughout this disclosure when referring to horizontal or vertical, unless the context expressly indicates otherwise). The drinking bottle assembly 2 includes a bottle portion 4, a lid 6, a strap 7, and a nozzle 8′ and nozzle cap 8. The nozzle cap 8 is designed to fit over a drinking nozzle (not shown) of the lid 6. The bottle portion 4 may be used to store a liquid (e.g., a consumable nutritional/supplement drink).

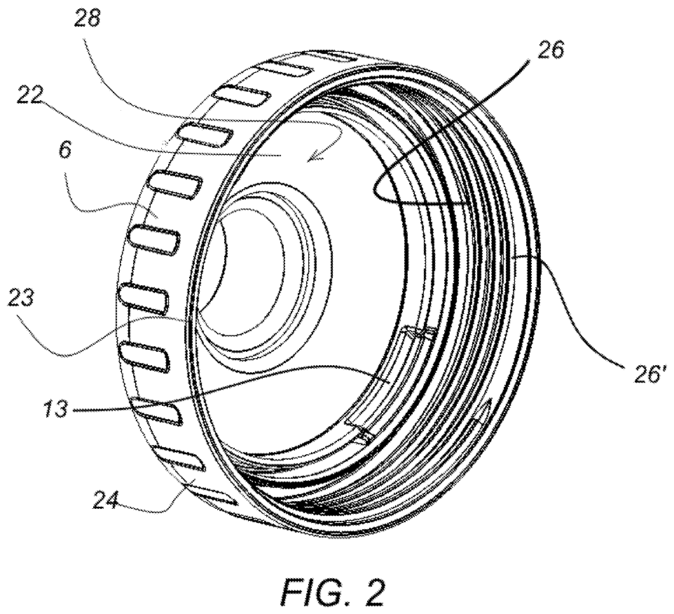

FIG. 2 illustrates the lid 6 of FIG. 1 disengaged from the bottle portion 4. In some embodiments, the lid 6 may have a drinking nozzle (not shown in FIG. 2) disposed on a top of portion of the lid 6, and a lid opening 22 defined by a lid rim 23, and coplanar with the lid rim 23. The lid 6 has an exterior surface 24 and an interior surface 26 opposite of the exterior surface 24. The lid opening 22 defines an entrance to an interior space 28, and the interior surface 26 defines a perimeter of the interior space 28. In some embodiments, the lid 6 may be removably secured and unsecured from the bottle portion 4 by screwing or unscrewing the lid 6 from the bottle portion 4, with the lid having interior threads 26′ and the bottle portion having mateable exterior threads (not shown), as will be appreciated by those skilled in the art upon reviewing this disclosure. In other embodiments, the lid 6 and bottle portion 4 may employ other types of engagement mechanism (e.g., something other than a threaded configuration).

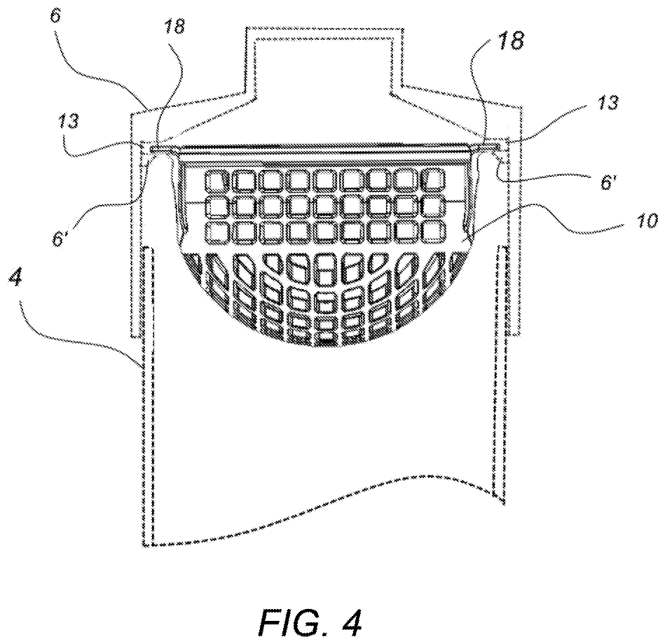

As illustrated in FIG. 4, in some embodiments, a screen member 10 is removably secured to the lid 6 within the interior space 28 thereof. In various embodiments, the screen member 10 is usable to increase and localize turbulence and provide an interior mixing member for assisting in solubilizing or suspending substances mixed into a liquid (e.g., powered supplements) when fluid is mixed by shaking the bottle before the fluid is dispensed. As will be appreciated by those skilled in the art after reviewing this disclosure, such turbulence can contribute to mixing a powder with a fluid inside the bottle.

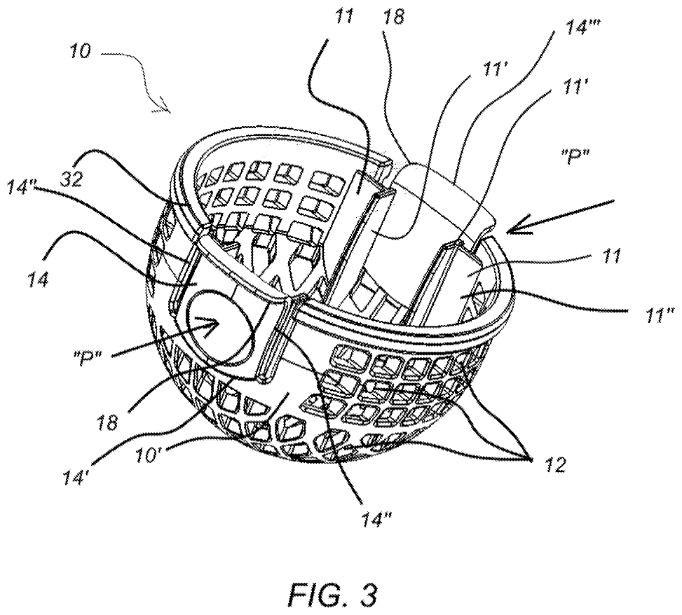

FIGS. 2 and 3 show views of the screen member 10 and lid 6 (as described above). In some embodiments, the screen member 10 includes a screen wall 10′ having a plurality of apertures 12, which may be dispersed over a majority of minority of the surface area of the screen wall 10′. The screen member 10 may be generally semispherical or hemispherical and have a substantially convex shape (relative to the lid 6 to which it can be removably attached). In various embodiments, the screen member 10 may be made from plastic, and/or other suitable material. The screen member 10 may further include a pair of tabs 14 disposed on opposite (e.g., diametrically opposed) sides of the screen member 10, the tabs 14 having a vertical length upper edge 14′″ that may be at least partially aligned with a substantially annular rim 32 of the screen member 10. In some embodiments, each of the tabs 14 has a horizontally outwardly protruding retaining member 18 disposed at a top portion of each of the tabs 14, protruding outward relative to the rim 32.

In some embodiments, a lower edge portion 14′ of the tabs 14 is connected to, or formed with, the screen wall 10′, while respective side edge portions 14″ of the tabs 14 may be free from, or detached from, the screen wall 10′ (e.g., a gap exists between each of the side edge portions 14″ and the screen wall 10′), such that a user can push each of the tabs 14 in a horizontally inwardly radial direction “P,” by, for example, squeezing the respective tabs between a thumb and forefinger, to cause the tabs 14 to pivot inward about the lower edge portions 14′. When a user releases a pressure otherwise applied against the tabs 14 to pivot them horizontally inward as described above, a resilient spring characteristic of the tabs 14, and/or of a connection portion between the lower edge portion 14′ and screen wall 10, causes the tabs 14 to pivot in a reverse direction, horizontally outward against the direction “P.”

By applying the inward pressure against the tabs 14 in the direction of “P,” to cause them to pivot inward about their lower edge portions 14′, a user can then insert the screen member 10 into the lid 6, with the entire rim 32 of the screen member 10 inserted into the interior space 28, and with the horizontally outwardly protruding retaining members 18 of the tabs 14 displaced far enough horizontally inward, to clear a ridge 6′ formed on the interior surface of the lid 6 (See, e.g., FIG. 4). After the retaining members 18 clear the ridge 6′, the user can release inward pressure on the tabs 14 to allow them to spring outward against the direction “P,” such that the retaining members 18 are biased outward into slots 13 formed above the ridge 6′. The slots 13 in the lid 6 can be seen in FIGS. 2 & 4, while FIG. 4 shows the screen member 10 removably secured to the lid 6 by retaining members 18 resting in the slots 13 after having cleared the ridge 6′, the retaining members 18 having been biased horizontally outward into the slots 13 by a resilient spring characteristic of the tabs 14, or the lower edge portions 14′ thereof.

Inward pressure may be applied to the tabs 14 in the direction of arrows “P” when the screen member 10 is removably secured to the lid 6, to bias the retaining members 18 radially inward. A user can then pull the screen member 10 downward (again, this direction is recited relative to the directional reference lines illustrated in FIG. 1, and for reference purposes only) from the lid 6 while the retaining members 18 are biased sufficiently horizontally inward to clear the ridge 6′ to be removed from the slots 13.

Referring again to FIG. 3, in some embodiments, one or more reinforcement structures are provided for each of the tabs 14. For example, each tab 14 can be provided with a pair of reinforcement structures 11, disposed horizontally radially inward of the tab 14. Each reinforcement structures includes at least one reinforcement wall 11″ disposed approximately parallel to a best fit plane of a corresponding tab 14, and at least another reinforcement wall 11′ disposed approximately perpendicular to the best fit plane of the corresponding tab 14, each of the reinforcement walls being connected to, or otherwise formed on, the screen member 10, inward of the corresponding tab 14. (A “best fit plane” relative to the tab is intended herein to mean a geometric plane positioned relative to the tab to maximize a cumulative area of the plane that aligns with any part of the tab 13). For example, in some embodiments, the reinforcement structures 11 are positioned proximate tab 14 to prevent a user from depressing the tabs 14 inward past the reinforcement structures 11 (which are stationary relative to the screen wall 10′, unlike portions of the tab 14 which can pivot about their connection portions to the screen wall 10′), as the tabs will abut the reinforcement structures 11 when pushed inward past a threshold amount of applied pressure.

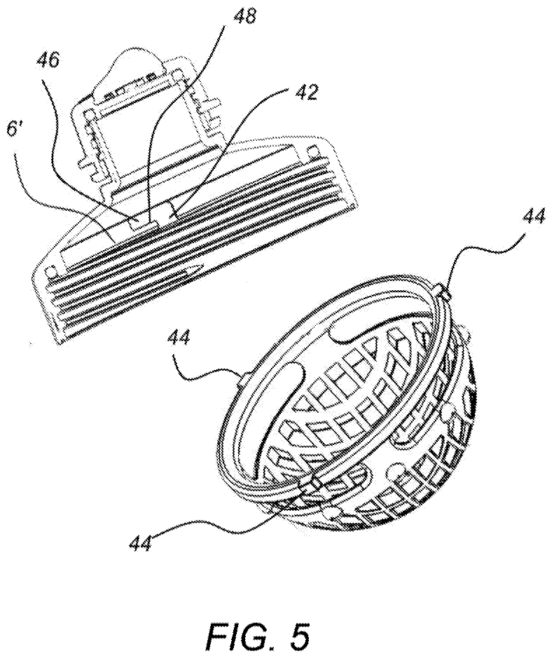

Referring to FIG. 5, in some alternative embodiments, a ridge member 6′ of the lid 6 includes at least one receiving notch 42, configured to receive at least one stationary protruding retaining member 44 formed on (or otherwise attached to) the screen member 10″ (the term “stationary” here being used relative to the screen member 10″, that is, the protruding member is not disposed on a pivotable tab, such as in the embodiment described above). The receiving notch 42 extends vertically upward into a receiving slot 46, the receiving slot being defined by at least one horizontally extending sidewall 48, extending horizontally away from the at least one receiving notch. In such embodiment, a user can push the screen member 10″ upward and twist it to secure it to the lid 6, by aligning the stationary protruding retaining member 44 with the notch 42, pushing it into the notch 42, and then twisting the screen member 10″ to slide the retaining member 44 into the receiving slot 46, to retain the screen member 10″ to the lid 6.

As will be appreciated by those skilled in the art after reviewing this disclosure, the removabilty of the screen member 10 provides many benefits, including, for example, without limitation, ease and quality of manufacturing assembly, and ease and quality of cleaning by the consumer.

The various embodiments described herein, are presented as non-limiting example embodiments of the present disclosure, unless otherwise expressly indicated. After reviewing the present disclosure, an individual of ordinary skill in the art will immediately appreciate that some details and features can be added, removed, and/or changed without deviating from the spirit of the disclosure. Reference throughout this specification to “various embodiments,” “one embodiment,” “an embodiment,” “additional embodiment(s)”, “alternative embodiments,” or “some embodiments,” means that a particular feature, structure or characteristic described in connection with the embodiment(s) is included in at least one or some embodiment(s), but not necessarily all embodiments, such that the references do not necessarily refer to the same embodiment(s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification, but should be construed to include all possible embodiments along with the full scope of equivalents to which such claims are entitled. Accordingly, the claims are not limited by the disclosure.

What is claimed is:

1. A bottle assembly comprising:
a bottle body for use in holding liquids;
a lid removably attachable to the bottle body, the lid having a rim defining an entrance opening for an interior space of the lid for receiving the bottle body, the lid having an interior surface defining at least a portion of the interior space, and the lid having an exterior surface opposite of the interior surface;
a screen member disposable within the interior space, the screen member including a plurality of apertures formed through a screen wall of the screen, the screen wall being connectable to the lid in a position such that the screen wall extends downwardly away from a portion of the lid in a convex shape;
wherein the screen member has a rim and at least one protruding retaining member protruding horizontally outward relative to the rim;
at least one ridge member disposed on the lid positioned horizontally inward from at least a portion of the interior surface of the lid; and
at least one slot formed above the ridge member for receiving the at least one protruding retaining member of the screen member, whereby the screen member is removably securable to the lid, at least in part, by the at least one protruding retaining member being removably inserted in the at least one slot.

2. The bottle assembly of claim 1 further comprising at least one pivotable tab connected to the screen wall, the pivotable tab, or a connection thereof to the screen wall, having a spring characteristic, such that a manual force can be applied to the tab to push the tab horizontally inward about a pivot location and the spring characteristic of the tab will bias the tab horizontally outward after the force is released.

3. The bottle assembly of claim 2 wherein the retaining member protrudes horizontally outward from an upper portion of the tab.

4. The bottle assembly of claim 3 wherein the tab is connected to the screen wall at a lower edge portion thereof, but at least a portion of side edges of the tab are not connected to the screen wall.

5. The bottle assembly of claim 3 further comprising at least one reinforcement wall disposed horizontally inward of the tab and connected to the screen wall, the at least one reinforcement wall being disposed substantially parallel to a plane fitted to the tab.

6. The bottle assembly of claim 5 further comprising at least a second reinforcement wall disposed horizontally inward of the tab and connected to the screen wall, the at least a second reinforcement wall being disposed substantially perpendicular to a plane fitted to the tab.

7. A method of mixing liquid in a bottle assembly comprising:
removably connecting a screen member to a bottle lid by:
applying a horizontally inward force against a flexible resilient tab portion of the screen member; and
inserting a retaining member on the tab into a slot formed on an interior surface of the lid;
removably connecting the bottle lid to a bottle body; and
agitating a liquid contained within the bottle assembly.

8. The method of claim 7 further comprising stopping an inward movement of the tab when the horizontally inward force is applied thereto, by abutting the tab against a reinforcement wall.

9. A bottle assembly comprising:
a bottle body for use in holding liquids;
a lid removably attachable to the bottle body, the lid having a rim defining an entrance opening for an interior space of the lid for receiving the bottle body, the lid having an interior surface defining at least a portion of the interior space, and the lid having an exterior surface opposite of the interior surface;
a screen member disposable within the interior space, the screen member including a plurality of apertures formed through a screen wall of the screen, the screen wall being connectable to the lid in a position such that the screen wall extends downwardly away from a portion of the lid in a convex shape;
wherein the screen member has a rim and at least one protruding retaining member protruding horizontally outward relative to the rim;
at least one ridge member disposed on the lid positioned horizontally inward from at least a portion of the interior surface of the lid, the at least one ridge member including at least one receiving notch configured to receive the at least one protruding retaining member; and
wherein the at least one receiving notch extends vertically upward into at least one receiving slot, the at least one receiving slot being defined by at least one horizontally extending sidewall extending horizontally away from the at least one receiving notch.

10. The bottle assembly of claim 9 wherein the horizontally extending sidewall of the at least one receiving slot has a semi-annular configuration.

11. The bottle assembly of claim 9 wherein the screen wall is shaped as, or approximates the shape of, a hemisphere.
